(19) United States
(12) Patent Application Publication
(10) Pub. No.: US 2025/0001841 A1
(43) Pub. Date: Jan. 2, 2025

(54) AUTOMATIC VEHICLE SUN VISOR CONTROL SYSTEM

(71) Applicant: DAEHAN SOLUTION CO., LTD, Incheon (KR)

(72) Inventors: Choong Ho KWON, SEOUL (KR); Min-Yong RYU, Incheon (KR)

(73) Assignee: DAEHAN SOLUTION CO., LTD, Incheon (KE)

(21) Appl. No.: 18/751,873

(22) Filed: Jun. 24, 2024

(30) Foreign Application Priority Data
Jun. 28, 2023 (KR) 10-2023-0833359

(51) Int. Cl. B60J 3/02; G06V 20/59

(52) U.S. Cl. CPC B60J 3/0208; B60J 3/0278; G06V 20/59

(57) ABSTRACT

The present invention is configured to detect whether sunlight that shines into an interior through a glass shines around eyes of a driver, detect an incident angle of the sunlight at the same time, and control an actuator to unfold a sun visor to block the sunlight which hinders a driving view of the driver, so that the driver can drive safely as the sun visor is automatically unfolded even without the driver manipulating the sun visor when there is a worry that the driving view of the driver will be hindered. In particular, the present invention can improve an effect of blocking the sunlight and allow the driver to drive safely by minimizing hindrance of a driving view of the driver by the sun visor by driving the actuator such that the sun visor is located to be perpendicular to an incident angle. In addition, the present invention is configured to block the sunlight by automatically operating an auxiliary sun visor when the sunlight shining around the eyes of the driver cannot be blocked using only the sun visor which rotates as described above, so that, even when an angle between the ground and the sun is small like when the sun sets or rises, an effect of blocking the sunlight is improved to allow the driver to drive safely.

### CROSS-REFERENCE TO RELATED APPLICATION

This application claims priority to and the benefit of Korean Patent Application No. 10-2023-0083359, filed on Jun. 28, 2023, the disclosure of which is incorporated herein by reference in its entirety.

### BACKGROUND

### 1. Field of the Invention

The present invention relates to an automatic vehicle sun visor control system, and more specifically, to an automatic vehicle sun visor control system which automatically blocks sunlight using a sun visor to allow a driver to safely drive without being affected by the sunlight when there is a worry that the sunlight may hinder a driving view of the driver by checking whether the sunlight shines around the eyes of the driver, detecting an angle at which the sunlight shines, and when the sunlight shines therearound, rotating the sun visor to be perpendicular to the sunlight to block the sunlight. In this case, when the sunlight shining around the eyes cannot be blocked even when the sun visor is rotated, an auxiliary sun visor included in the sun visor slides to block the sunlight.

### 2. Discussion of Related Art

In general, a sun visor is mounted in a vehicle to block sunlight shining into a vehicle interior through the glass such that a driving view is not hindered by the sunlight when a driver drives. Since an area of such a sun visor is fixed, a situation in which sunlight shining into an interior is not completely blocked only by the sun visor may occur to a driver whose body is not large or who uses a seat while significantly tilting the seat backward, and thus a situation in which safe driving is hindered may occur.

In the following Patent Documents 1 to 3, technologies of blocking sunlight to allow a driver to safely drive by mounting an auxiliary sun visor on a sun visor are disclosed as methods for solving such problems.

### (Patent Document 1) Korean Utility Model Registration No. 20-0359893

This relates to an attachable and detachable auxiliary vehicle sunshade. The attachable and detachable auxiliary vehicle sunshade is conveniently attached to or detached from a sunshade, which is rotatably mounted on a front side of a headliner of a vehicle to block sunlight passing through a front windshield glass and a front door glass of the vehicle, to block the sunlight as necessary to further improve the driving safety of a driver, and shields the driver and passengers on passenger seats from being exposed to ultraviolet rays. A configuration for achieving the above-described objectives includes a resin film which is formed on the auxiliary vehicle sunshade, which is conveniently and detachably attached to or detached from a vehicle sunshade to more reliably block sunlight transmitted when sunlight shines in an almost horizontal direction such as at sunrise or sunset, has a wider area than the vehicle sunshade, and is transparent while blocking the sunlight and ultraviolet rays and a bending member which couples the resin film to the sunshade.

### (Patent Document 2) Korean Utility Model Registration No. 20-0320702

A core configuration is that an auxiliary awning plate may be coupled to a lower surface of a known awning plate (that is, a lower surface of the awning plate in a state in which the awning plate is unfolded to be used) to be freely rotated in any direction. Since the two awning plates are relatively freely rotated, when the two awning plates are not used, the two awning plates can be stacked, folded, and temporarily stored in a ceiling of a vehicle. In addition, since, according to necessity, either the auxiliary awning plate is not unfolded and only the known awning plate is used, or the two awning plates are both unfolded and used, ease of use can be maximized.

### (Patent Document 3) Korean Utility Model Registration No. 20-0246849

This relates to an auxiliary sun visor including a body part, which is installed to surround a sun visor rotatably installed on a center adaptor having one side end of a hinge shaft installed on a roof and in which a front plate and a rear plate are integrally formed around a bent part of an upper center such that the body part is selectively moved in a horizontal direction, an auxiliary sun visor plate installed on a rear plate of the body part, and an extending unit which extends the auxiliary sun visor plate from the body part. Moving holes are formed in a front plate and a rear plate of the extending unit, one side of the auxiliary sun visor plate is fixed to the body part by a restriction member, and the auxiliary sun visor plate is extended downward by the body part vertically rotating along the moving hole in the sun visor. Accordingly, the auxiliary sun visor may be installed on the sun visor installed in a vehicle interior and used after being horizontally moved or vertically rotated to selectively increase a width of a shade using the auxiliary sun visor plate fixedly installed on the rear plate through manipulation of a user. In addition, it discloses a very useful invention that can secure a driver's view to improve convenience and promote safe driving by widely blocking direct light through only a simple manipulation such as horizontal movement or vertical rotation.

### RELATED ART

### Patent Documents

(Patent Document 1) Korean Utility Model Registration No. 20-0359893 (Registered Date: Aug. 13, 2004)
(Patent Document 2) Korean Utility Model Registration No. 20-0320702 (Registered Date: Jul. 8, 2003)
(Patent Document 3) Korean Utility Model Registration No. 20-0246849 (Registered Date: Sep. 4, 2001)

### SUMMARY OF THE INVENTION

However, such an existing sun visor has the following problems.

(1) Although a sun visor can block sunlight which hinders a driving view of a driver, there is the inconvenience that the driver should directly manipulate the sun visor.

(2) In this case, when the sun visor is adjusted, the user should use a hand, and it is not easy to adjust an angle at which the sunlight is blocked by tilting the sun visor backward using one hand while holding a steering wheel with the other hand.

(3) In addition, tilting the sun visor to correspond to the angle at which the sunlight is transmitted can interrupt concentration and lead an accident.

(4) Meanwhile, when a transmission direction and an incident angle of the sunlight shining into a vehicle interior are continuously changed in the case in which a road along which the vehicle travels is not a straight road or the vehicle travels along a curved road, the driver cannot adjust an unfolding angle of the sun visor in time.

(5) In addition, when the driver drives for a long time while facing the sun at sunset, an angle of the sun visor should be continuously lowered as the sun continuously moves downward. However, since there is a limitation on a width of the sun visor, a driving view can be hindered.

(6) Although the sun visor can be manufactured to have a large size, when a wider sun visor is used, the driving view of the user can be hindered by the sun visor and cause a bigger accident.

The present invention is disclosed in consideration of the above problems and is directed to providing an automatic vehicle sun visor control system which detects whether sunlight that shines into an interior through a glass shines around eyes of a driver, detects an incident angle of the sunlight at the same time, and controls an actuator to unfold a sun visor to block the sunlight which hinders a driving view of the driver, so that the driver can drive safely as the sun visor is automatically unfolded even without the driver manipulating the sun visor when there is a worry that the driving view of the driver will be hindered.

In particular, the present invention is also directed to providing an automatic vehicle sun visor control system which improves an effect of blocking sunlight and allows a driver to drive safely by minimizing hindrance of a driving view of the driver by a sun visor by driving an actuator such that the sun visor is located to be perpendicular to an incident angle of the sunlight.

In addition, the present invention is also directed to providing an automatic vehicle sun visor control system which blocks sunlight by automatically operating an auxiliary sun visor when the sunlight shining around eyes of a driver cannot be blocked using only a sun visor which rotates as described above, so that, even when an angle between the ground and the sun is small like when the sun sets or rises, an effect of blocking the sunlight is improved to promote safe driving.

According to an aspect of the present invention, there is provided an automatic vehicle sun visor control system, which includes a rotary shaft (41) having one side mounted on a headliner and the other side fixed to a sun visor body (40), including at least one camera (10) installed in a vehicle for detecting whether sunlight shines around eyes of a driver, at least one angle sensor (20) installed in the vehicle for detecting an incident angle of sunlight incident through a glass window, an actuator (30) which is installed between a portion and the rotary shaft (41) and forcibly rotates the sun visor body (40) connected to the rotary shaft, wherein the portion is separated from the rotary shaft (41), an auxiliary sun visor (42) which is installed in the sun visor body (40) to protrude downward when the sun visor body (40) is unfolded, a rack-pinion gear (44) installed in the sun visor body (40) and driven by a driving motor (43) such that the auxiliary sun visor (42) slides, and a controller which, when sunlight shines in the eyes of the driver, controls the actuator (30) and the driving motor (43) to operate to rotate the sun visor body (40) to intersect the incident angle such that the sunlight does not shine in the eyes of the driver.

In particular, the controller may control the actuator (30) to rotate the sun visor body (40) to be perpendicular to the incident angle detected by the angle sensor (20).

In addition, when the sunlight shines in the eyes of the driver even when the sun visor body (40) is perpendicular to the incident angle detected by the angle sensor (20), the controller may control the driving motor (43) such that the auxiliary sun visor (42) protrudes downward to prevent the sunlight from shining in the eyes of the driver.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a vehicle to which an automatic vehicle sun visor control system according to the present invention is applied;

FIG. 2 is a perspective view illustrating a configuration of the automatic vehicle sun visor control system according to the present invention when viewed forward in a vehicle interior;

FIG. 3 is a side view illustrating a vehicle for showing mounting locations of a camera and an angle sensor according to the present invention;

FIG. 4 is side view illustrating a state in which a sun visor rotates to correspond to an incident angle of sunlight according to the present invention; and

FIG. 5 is a side cross-sectional view illustrating the sun visor in which an auxiliary sun visor protrudes in a state in which the sun visor is rotated to correspond to the incident angle of the sunlight.

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

### Configuration of Automatic Vehicle Sun Visor Control System

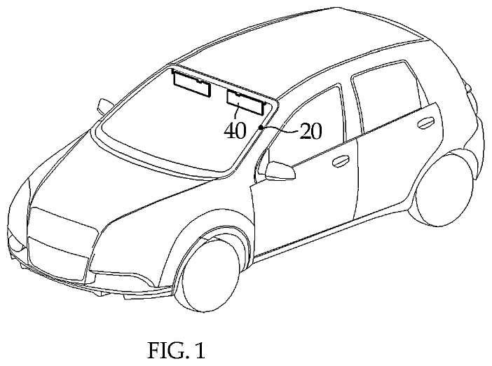

As illustrated in FIGS. 1 to 5, an automatic vehicle sun visor control system according to the present invention includes a camera 10, an angle sensor 20, an actuator 30, an auxiliary sun visor 42, a rack-pinion gear 44, and a controller.

In particular, whether sunlight shines around the eyes of a driver is checked using the camera 10, and when the sunlight shines around the eyes, a sun visor body 40 is automatically rotated to intersect an angle detected by the angle sensor 20 to block the sunlight from shining around the eyes of the driver in order for the driver to drive safely.

In this case, the sun visor body 40 may be rotated to be perpendicular to the angle detected by the angle sensor 20 so that the sun visor body 40 minimally hinders a driving view of the driver while improving an effect of blocking the sunlight.

In addition, as described above, when some of the sunlight shines around the eyes of the driver even when the sun visor body 40 rotates to block the sunlight, the auxiliary sun visor 42 is controlled by the controller and protrudes from the sun visor body 40 to block the sunlight from shining around the eyes of the driver.

Hereinafter, such a structure will be described in more detail below with reference to the accompanying drawings. In the drawings, an arrow having an arrowhead filled with black indicates a direction of sunlight, and an arrow having a hollow arrowhead indicates an operational direction of the corresponding component.

### A. Camera

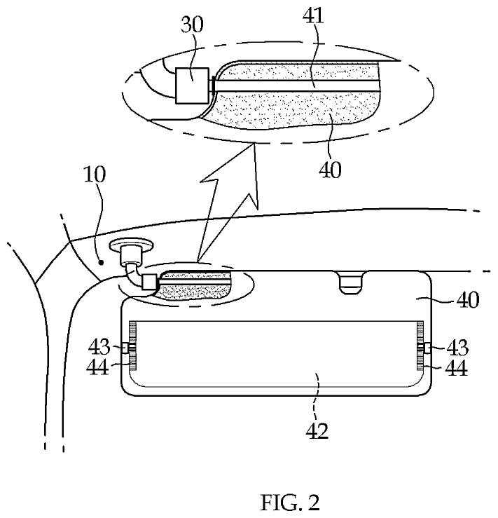

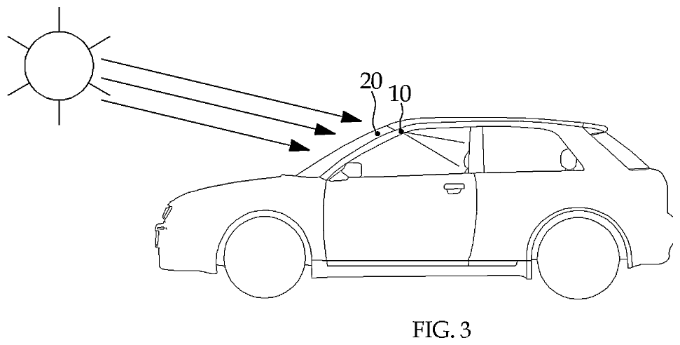

As illustrated in FIGS. 2 and 3, the camera 10 is for detecting whether the sunlight shines around the face, particularly around the eyes, of the driver and hinders driving. The camera 10 may be mounted in a vehicle interior at any location from which an image of the face of the driver may be captured, and at least one camera 10 is mounted to check whether the sunlight shines around the eyes. The camera allows whether the sunlight shines around the eyes of the driver to be checked by comparing whether the surroundings of the eyes shine brightly or the like in the captured image, and when it is determined that the sunlight shines around the eyes of the driver, outputs to the controller, which will be described below, a signal related to the determination to rotate the sun visor body 40 to block the sunlight from shining around the eyes of the driver. A camera manufactured using the conventional technology used in the art to which the present invention belongs may be used as the camera 10.

### B. Angle Sensor

As illustrated in FIGS. 1 and 3, the angle sensor 20 is a sensor for detecting an incident angle of sunlight which is incident through a window of the vehicle. An example of the angle sensor 20 may be a sun sensor which traces a location of the sun, an illumination sensor which estimates an angle at which sunlight shines by detecting an illumination level due to the sunlight to check an intensity of the sunlight, a Global Positioning System (GPS) sensor which predicts an angle at which sunlight shines on the basis of GPS information, a location of a vehicle, and time information, or the like. An angle sensor manufactured using the conventional technology used in the art to which the present invention belongs may be used as the angle sensor 20.

### C. Actuator

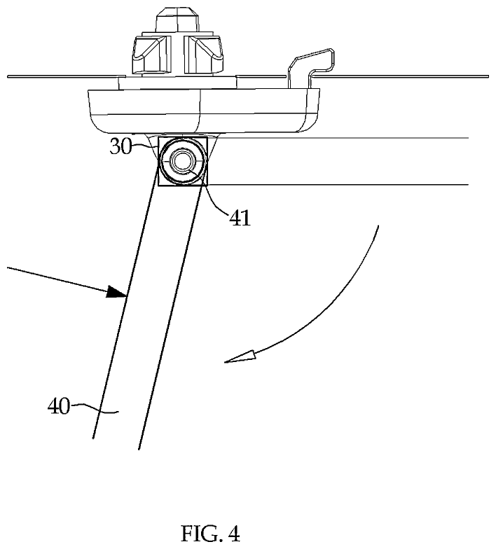

As illustrated in FIGS. 2 and 4, the actuator 30 is mounted on a rotary shaft 41 which rotatably supports the sun visor body 40. In this case, the sun visor body 40 is manufactured using the conventional technology to be mounted on a headliner in the vehicle interior and unfolded to block the sunlight which is incident into the vehicle interior through a glass in a state in which the driver is close contact with the headliner during driving to allow the driver to drive safely. In addition, the rotary shaft 41 is a shaft which is manufactured using the conventional technology and of which one side is mounted on the headliner and the other side is fixed to the sun visor body 40.

In this case, as illustrated in FIGS. 2 and 4, a portion is separated from the shaft 41, and the actuator 30 is fixedly mounted between the separated portion and the shaft 41. In addition, a shaft of the actuator 30 is connected to the rotary shaft 41 connected to the sun visor body 40, so that the sun visor body 40 can be folded and unfolded as the actuator 30 rotates. In this case, any actuator capable of rotating the rotary shaft 41 divided as described above may be used as the actuator 30, and an example of the actuator 30 may be a forward and backward motor.

The actuator 30 is controlled by the controller, which will be described below, to block the sunlight from shining around the eyes of the driver by matching an angle at which the sunlight is transmitted.

### D. Auxiliary Sun Visor, Driving Motor, and Rack-Pinion Gear

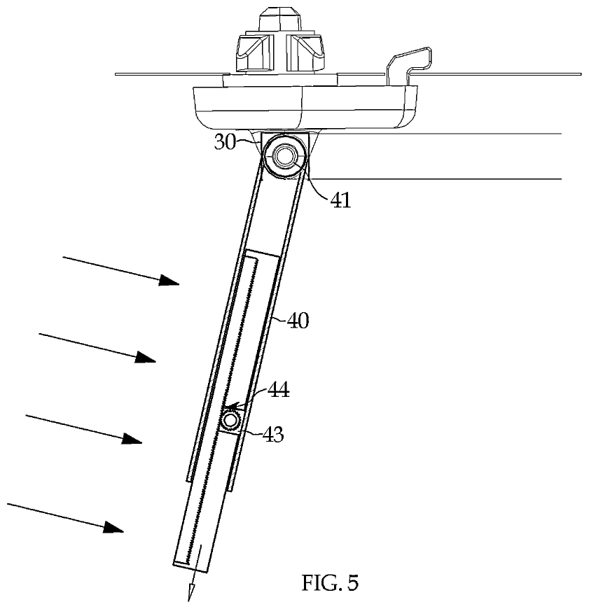

As illustrated in FIGS. 2 and 5, the auxiliary sun visor 42 is a component for extending an area of the entire sun visor downward from the inside of the sun visor body 40 when the sun visor body 40 is unfolded. Accordingly, the auxiliary sun visor 42 may be formed to have a smaller area than the sun visor body 40 and preferably formed to have substantially the same area as the sun visor body 40.

As illustrated in FIGS. 2 and 5, the driving motor 43 is a motor for transmitting power so that the auxiliary sun visor 42 is forcibly withdrawn downward from the sun visor body 40 or the withdrawn auxiliary sun visor 42 is stored in the sun visor body 40. Accordingly, a driving motor capable of performing control in a forward direction and a backward direction may be used as the driving motor 43.

As illustrated in FIGS. 2 and 5, the rack-pinion gear 44 is a gear for receiving a driving force of the driving motor 43 and changing the driving force into a straight motion. In this case, a rack is mounted on the auxiliary sun visor 42 in a width direction, and a pinion is engaged with the rack to receive the driving force of the driving motor 43 and rotate in place so that the rack moves forward or backward in a longitudinal direction. In the drawings, the rack-pinion gear 44 is illustrated as a pair of rack-pinion gears 44 installed on both sides of the auxiliary sun visor 42. Accordingly, one driving motor 43 may be driven for each rack-pinion gear 44, and the pair of rack-pinion gears 44 may also be controlled to operate using one driving motor 43.

### E. Controller

As illustrated in FIGS. 3 to 5, the controller receives signals of the camera 10 and the angle sensor 20 and controls the actuator 30 and the driving motor 43 to prevent the sunlight passing through the glass from shining around the eyes of the driver in order for the driver to drive safely.

To this end, as illustrated in FIG. 3, the controller captures an image of the face of the driver using the camera 10 to detect whether the sunlight shines around the eyes of the driver. In this case, when the sunlight shines around the eyes, the controller operates the actuator 30 to forcibly rotate the sun visor body 40 to prevent the sunlight from shining around the eyes of the driver.

In the exemplary embodiment of the present invention, as illustrated in FIG. 4, the controller detects an angle of the sunlight passing through the glass using the angle sensor 20 and rotates the sun visor body 40 by controlling an amount of rotation of the sun visor body 40 on the basis of the detected angle. This is to, by rotating the sun visor body 40 at an angle perpendicular to the incident angle of the sunlight, not only block the sunlight from shining around the eyes of the driver using the sun visor body 40 but also minimize blockage of a driving view of the driver by the sun visor body 40 so that a front view is still visible when the sun visor body 40 is rotated.

Meanwhile, as illustrated in FIG. 5, when the sunlight shines around the eyes of the driver even when the controller controls the actuator 30, the controller drives the driving motor 43 to operate the rack-pinion gear 44 such that the auxiliary sun visor 42 protrudes downward to block the sunlight shining around the eyes of the driver.

As described above, the present invention allows safe driving by automatically rotating the sun visor body to block sunlight shining in a location of eyes of a driver when the sunlight shines around the eyes. In addition, when the sunlight is not blocked even when the sun visor body is rotated as described above, the auxiliary sun visor protrudes downward to block the sunlight shining around the eyes so that the driver can drive safely.

An automatic vehicle sun visor control system according to the present invention has the following effects.

(1) A sun visor can be automatically unfolded to block sunlight shining around the face of a driver so that the driver can drive safely even without the driver directly unfolding or folding the sun visor when the sunlight shines around the eyes of the driver.

(2) In particular, since the sun visor rotates to be perpendicular to the sunlight passing through a glass, the sun visor can block the sunlight incident into a vehicle interior so that the driver can drive safely, and the driver can secure a wide driving view by minimizing hiding of the driving view of the driver by the sun visor.

(3) Meanwhile, an auxiliary sun visor is mounted on the sun visor, and since the auxiliary sun visor is unfolded to block the sunlight passing through the glass when the sunlight shining around the eyes of the driver is not completely blocked by only rotating the sun visor, the effect of blocking the sunlight is improved so that the driver whose body is small or who has a habit of driving while leaning backward can drive safely when the sunlight shines almost horizontally like when the sun sets or rises.

(4) Since basic mechanical units such as a motor and a rack-pinion are used such that the sun visor rotates and the auxiliary sun visor operates, not only is a structure simple and easily manufactured for convenient use, but also the maintenance thereof is easy.

(5) In addition, since the auxiliary sun visor is used, the sun visor can be extended widely as described above even without being manufactured with a wide area, and the sunlight can be prevented from shining around the eyes of any driver.

What is claimed is:

1. An automatic vehicle sun visor control system, which includes a rotary shaft (41) having one side mounted on a headliner and the other side fixed to a sun visor body (40), comprising:
at least one camera (10) installed in a vehicle for detecting whether sunlight shines around eyes of a driver;
at least one angle sensor (20) installed in the vehicle for detecting an incident angle of sunlight incident through a glass window;
an actuator (30) which is installed between a portion and the rotary shaft (41) and forcibly rotates the sun visor body (40) connected to the rotary shaft, wherein the portion is separated from the rotary shaft (41);
an auxiliary sun visor (42) which is installed in the sun visor body (40) to protrude downward when the sun visor body (40) is unfolded;
a rack-pinion gear (44) installed in the sun visor body (40) and driven by a driving motor (43) such that the auxiliary sun visor (42) slides; and
a controller which, when sunlight shines in the eyes of the driver, controls the actuator (30) and the driving motor (43) to operate to rotate the sun visor body (40) to intersect the incident angle such that the sunlight does not shine in the eyes of the driver.

2. The automatic vehicle sun visor control system of claim 1, wherein the controller controls the actuator (30) to rotate the sun visor body (40) to be perpendicular to the incident angle detected by the angle sensor (20).

3. The automatic vehicle sun visor control system of claim 2, wherein, when the sunlight shines in the eyes of the driver even when the sun visor body (40) is perpendicular to the incident angle detected by the angle sensor (20), the controller controls the driving motor (43) such that the auxiliary sun visor (42) protrudes downward to prevent the sunlight from shining in the eyes of the driver.
